(19) United States
(12) Patent Application Publication
(10) Pub. No.: US 2003/0039527 A1
(43) Pub. Date: Feb. 27, 2003

(54) Connecting element in the form of a screw, nut or washer for a screw connection, and method for the tightening thereof

(76) Inventor: Volker Schatz, Remscheid (DE)

Correspondence Address: ALIX YALE & RISTAS LLP, 750 MAIN STREET, SUITE 1400, HARTFORD, CT, 06103, US

(21) Appl. No.: 10/195,755

(22) Filed: Jul. 15, 2002

Related U.S. Application Data
(63) Continuation of application No. PCT/EP01/00504, filed on Jan. 17, 2001.

(30) Foreign Application Priority Data
Jan. 18, 2000 (DE) 100 01 857.2

(51) Int. Cl. F16B 31/02

(52) U.S. Cl. 411/9

(57) ABSTRACT

A connecting element in the form of a screw or bolt, nut or washer for a screw connection has at its bearing surface at least one projection and at least one radially further outwardly disposed surface region. The height and cross-section of the projection are so dimensioned that on tightening of the screw connection the projection is elastically or plastically deformed to such an extent that on reaching a predetermined prestress force the radially outwardly disposed area region comes into engagement. When the screw connection, usual in practice, is tightened up to a predetermined tightening torque, the invention reduces the tolerance range of the prestress force corresponding to the tightening torque. The change in the torque vs. rotational angle differential quotient which occurs when the projection has been sufficiently deformed for the radially outwardly disposed area region to come into engagement may also be employed as criterion for terminating the tightening operation.

### CROSS REFERENCE TO RELATED APPLICATION

This is a continuation of International Application PCT/EP01/00504, filed on Jan. 17, 2001, which claims the priority of German Application 100 01 857.2 filed on Jan. 18, 2000.

### BACKGROUND OF THE INVENTION

The invention relates to a connecting element in the form of a screw or bolt, nut or washer for a screw connection. The connecting element has an annular engaging or bearing surface adapted to bear on a corresponding counter surface of a structural part to be connected. The invention also relates to a method for tightening a screw connection including the connecting element.

It is important in modern production engineering to tighten highly stressed screw connections in defined manner so that a predetermined minimum prestress force is achieved in the screw connection. If the force is below this minimum the screw connection is not sufficiently stressed or loaded and can loosen. On the other hand, a defined maximum prestress force must not be exceeded since otherwise the screw connection is overloaded and can be prematurely fatigued or ruptured. The objective is therefore to achieve the narrowest possible tolerance of the prestress force reached on tightening the screw connection.

The prestress force or initial strain cannot be measured directly. Instead, as a rule the torque exerted when tightening the screw connection is measured. The prestress force can be calculated from the tightening torque. The relationship between the torque and the prestress force depends among other things on the frictional relationships between the screw and the structural part to be connected thereby, a particularly significant part being played by the friction between the bearing surface of the screw head or nut and the corresponding counter surface of the structural part to be connected. The frictional properties between the engaging or bearing surface and the counter surface, expressed by the coefficient of friction μ, are subject in practice to considerable fluctuations depending for example on the lubrication state of the respective surfaces. This great tolerance in the coefficients of friction occurring in practice leads to a correspondingly large tolerance of the prestress force of the screw connection to be associated with a measured tightening torque.

To explain this, attention is drawn to FIG. 5 of the drawings. This shows graphically the relationship between the tightening torque m plotted along the abscissa and the prestress force f plotted along the ordinate for two different typical values of the coefficient of friction μ=0.16 (straight line A) and μ=0.08 (straight line B). The numerical values given along the coordinate axis are examples of values typical for a screw connection having the thread size M10. In case the coefficient of friction μ=0.16, the prestress force F which is reached on increasing the tightening torque M increases linearly along the straight line A and at a predefined value M_{A} of the tightening torque the prestress force reaches a recommended minimum value F1 of, for example, 15 kN. If, however, the coefficient of friction is only μ=0.08, with increasing tightening torque M the prestress force F will rise according to the straight line B because a smaller portion of the tightening torque M is required to overcome the friction. For the same predetermined value M_{A} of the tightening torque M the prestress force achieved is now, for example, F2=30 kN. The tolerance of the coefficient of friction μ therefore leads to a very large tolerance range ΔF of the prestress force achieved for a given tightening torque M_{A}. In the example according to FIG. 5, the tolerance range ΔF=15 kN amounts to 100% of the minimum prestress force F1. Such a large tolerance range may result in the prestress force F2 at the upper range limit being greater than the maximum prestress force recommended for the bolt or screw type concerned. This may make it necessary to use a screw which can withstand a greater load than would be necessary for the minimum prestress force F1.

DE 37 41 510 A1 discloses a self-locking connecting element in the form of a bolt or screw, nut or washer on the bearing face of which at least one angular projection is formed. This annular projection is intended to dig into the material of the counter surface and thereby fix the screw head, nut or washer to secure the screw connection from loosening. For the same purpose a self-locking securing element known from DE 36 41 836 A1 comprises on its engaging or bearing face protuberances and depressions in the form of grid-like patterns which press themselves into the counter surface with the aim of thereby locking the securing element to prevent rotation in the loosening direction.

### SUMMARY OF THE INVENTION

The invention is based on the problem of configuring a connecting element comprising a screw connection, in particular a bolt or screw, nut or washer, in such a manner that the friction-dependent tolerance range of the prestress force of the screw connection achieved for a given tightening torque is reduced.

A further objective of the invention is to provide an assembly method for such a screw connection which permits tightening of the screw connection to the defined minimum prestress force which is substantially independent of the particular coefficients of friction present.

The solution according to the invention is based on the change in the frictional situation which occurs when at least one projection, on reaching the minimum prestress force prescribed for the respective screw connection, has been deformed to such an extent that areas of the bearing surface disposed radially outside the projection come to bear on the counter surface. This results in a sudden increase in the effective radius of the areas of bearing surface and counter surface which are in frictional contact. The invention requires careful dimensioning of the cross-section and the height of the projection so that the necessary deformation of said projection is achieved exactly on reaching a predetermined minimum prestress force of the screw connection and the areas of the bearing surface disposed radially outside the projection then become loadbearing.

### BRIEF DESCRIPTION OF THE DRAWING

The invention will be explained in detail with the aid of examples of embodiments with reference to the drawings, wherein:

FIG. 1 is a side elevation of a screw or bolt formed according to the invention, partially in longitudinal section.

FIG. 2 shows in section a screw connection formed according to the invention and having a washer.

FIG. 3 shows in section another example of an embodiment of a screw head formed according to the invention.

FIG. 4 shows a further example of an embodiment of a screw head.

FIG. 5 is a graphical illustration of the relationship between the tightening torque and prestress force for a screw according to the prior art.

FIG. 6 shows a graphical diagram corresponding to FIG. 5 for a screw formed according to the invention.

FIG. 7 is a graphical diagram for explaining the assembly method according to the invention.

### DETAILED DESCRIPTION OF THE PREFERRED EMBODIMENTS

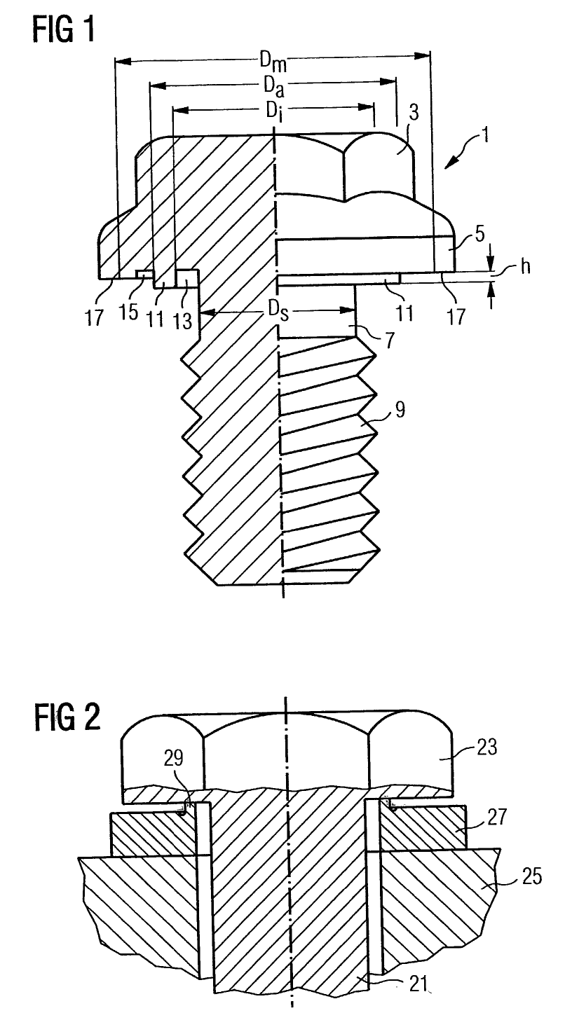

The bolt or screw 1 illustrated in FIG. 1 is a collar screw having an hexagonal head 3 which is enlarged by a radially projecting collar or flange 5 and which is adjoined by a shank 7 with threaded portion 9. Dₛ indicates the diameter of the shank 7 which is the same as the core diameter of the threaded portion 9.

At the lower side of the screw head 3 or its collar 5, there is an engaging or bearing surface which in conventional bolts or screws is a planar surface. In the screw illustrated in FIG. 1, an annular projection 11 is formed in the bearing surface near the shank 7 and is defined radially inwardly and outwardly by respective annular grooves 13, 15. The radially outer annular groove 15 separates the projection 11 from a radially further outwardly disposed annular outer region 17 of the bearing surface. In the example of an embodiment, the annular projection 11 has a rectangular cross-section with an inner diameter Dᵢ and an outer diameter Dₐ. The inner diameter Dᵢ of the projection 11 is preferably equal to or only slightly greater than the outer diameter of the threaded portion 9. The outer diameter Dₐ is chosen so that the annular area (Dₐ²−Dᵢ²)π/4 is not larger than and is preferably smaller than the cross-sectional area Dₛ²π/4 of the screw shank 7. Compared with the outer region 17 of the bearing surface the projection 11 has a difference (height) indicated at h on the right of FIG. 1. The height difference h is shown in exaggerated in size in FIG. 1. In practical cases, it is of the order of magnitude of about 0.01 mm or less.

When the screw or bolt 1 is screwed tight on a structural part firstly the end face of the projection 11 comes to bear on the counter surface of the structural part. From this moment on, on further tightening of the screw a frictional force beneath the projection 11 must be overcome and the magnitude of the force depends on the coefficient of friction μ and the mean diameter Dₐ−Dᵢ of the projection 11 (in addition to the frictional force occurring at the threaded portion). On further tightening of the screw, the projection 11 is elastically and possibly finally also plastically, deformed in the axial direction so that its height decreases. The dimensions of the projection 11, i.e. its width, the height difference h and the total height of the projection 11 defined by the depth of the grooves 13, 15 are so chosen in combination with the material properties of the screw 1 that on reaching a predetermined prestress force the height difference h disappears and the end face of the projection 11 lies flush with the outer region 17 of the bearing surface. At this moment the outer region 17 of the bearing surface also comes into contact with the counter surface of the structural part, and on further tightening of the screw it is necessary to overcome a frictional force between the outer region 17 and the counter surface of the structural part, which frictional force depends on the coefficient of friction μ and the mean diameter of the outer region 17 indicated at Dₘ. Since this mean diameter Dₘ is appreciably greater than the mean diameter of the projection 11, at a predetermined prestress force, where the height difference h disappears, there will occur an abrupt increase in the frictional force to be overcome between the bearing surface of the screw head 13 and the counter surface of the structural part.

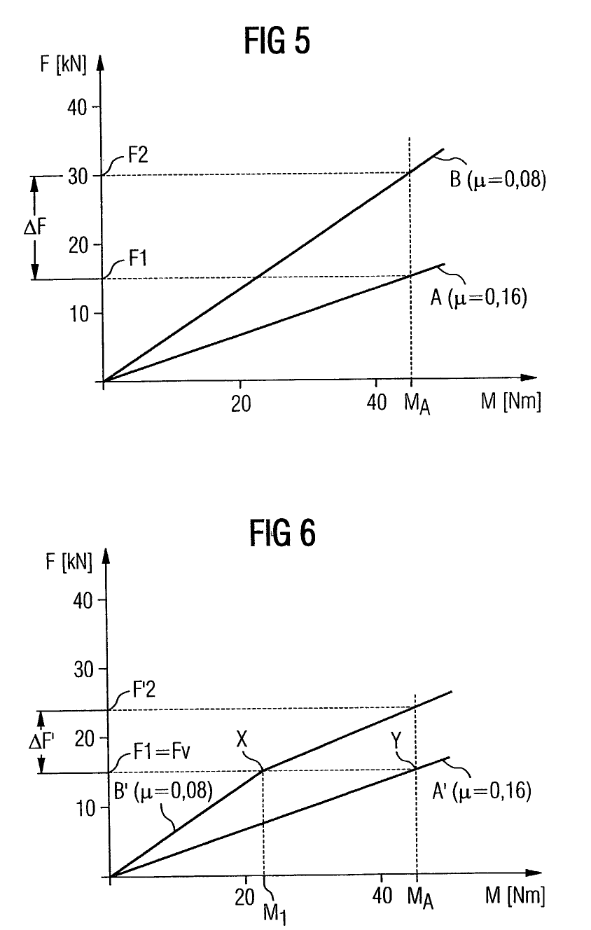

The effect achieved in this manner will be explained with the aid of FIG. 6 which corresponding to FIG. 5 shows the relationship between the tightening torque M and the prestress force F for two different values of the coefficient of friction μ=0.16 (straight line A′) and μ=0.08 (straight line B′). If the coefficient of friction μ=0.16, on increasing tightening torque M the prestress force F generated in the screw thus rises according to the straight line A′ and at the predetermined value M_{A} of the tightening torque reaches the value F1 which may for example be 15 kN as in FIG. 5. If the coefficient of friction μ=0.08 the prestress force increases with increasing tightening torque M corresponding to the steeper curve B′ until at the point X corresponding to a torque M1 a prestress force Fᵥ is reached at which the projection 11 is deformed to such an extent that the height difference h (FIG. 1) disappears. At this instant the outer region 17 of the bearing surface comes into frictional contact with the counter surface of the structural part, and as explained before, an abrupt increase occurs in the frictional resistance or the resistance torque caused thereby. As a result, the curve B′ extends appreciably flatter from the point X onwards than before said point X or than the curve B in FIG. 5. Once the tightening torque M has reached the predetermined value M_{A} the associated prestress force F′2 reached corresponding to the curve B′ has a value which is appreciably smaller than the value F2 in FIG. 5 and is for example only 24 kN. The tolerance range ΔF′ associated with the tightening torque Mₐ due to the different coefficients of friction μ=0.16 and μ=0.08 is considerably smaller than the tolerance range ΔF according to FIG. 5 for a conventional screw and in the example according to FIG. 6 is only 60% of the prestress force F1 at the lower range limit.

The numerical values apparent from FIGS. 5 and 6 are non-limiting and are typical values for an M10 screw. For each screw type and each screw size, a prestress force is prescribed or recommended by standards. For an M10 screw of the quality 8.8 the minimum value thereof is 15 kN and the maximum value 25 kN. For a normal screw, in accordance with FIG. 5, it is possible that with a tightening torque M_{A}, which is sufficient to reach the minimum prestress force F1 of 15 kN, a larger prestress force F2 of 30 kN can also be reached, because of the large tolerance ΔF which force F2 is greater than the admissible or recommended maximum tightening force of 25 kN. Consequently, a screw of greater strength or a larger screw must then be used, for example an M12 screw. If on the other hand a screw configured according to the invention is employed the tolerance range ΔF′ associated with the tightening torque M_{A} is only between 15 and 24 kN and thus does not go beyond the recommended maximum value of 25 kN. Consequently, an M10 screw of quality 8.8 can be employed without any safety hazard.

If the screw shown in FIG. 1 is an M10 screw, the following dimensions preferably apply:

| | |
|---|---|
| Shank diameter Dₛ = | 10 mm; |
| Inner diameter Dᵢ of the projection 11 = | 11 mm; |
| Outer diameter Dₐ = | 14 mm; |
| Depth and width of each of the grooves 13 and 15 = | 1 mm; |
| Mean diameter Dₘ of the outer region 17 of the | 20 mm; |
| bearing surface = | |
| Outer diameter of the collar 5 of the screw Head = | 25 mm. |

The height h of the annular projection 11 over the outer region 17 of the bearing surface can be calculated from the formula

$$h = \frac{{h}_{o} \cdot {F}_{v} \cdot 4}{( {D}_{a}^{2} - {D}_{i}^{2} ) \cdot E \cdot π}$$

where hₒ is the overall axial height of the projection 11 measured from the bottom of the grooves 13, 15, Fᵥ the prestress force at which the height h is to disappear, E the modulus of elasticity of the material of the screw and Dₐ and Dᵢ the outer and inner diameters of the projection 11. A calculation example with typical numerical values leads to the value h=0.01 mm.

The prestress force Fᵥ at which the height h of the projection 11 disappears by deformation is preferably at least approximately equal to the minimum prestress force F1 required for the particular screw type. If said prestress force Fᵥ differs from the recommended minimum prestress F1, the result is that in FIG. 6 the point X at which the slope of the curve B changes comes to lie beneath or above the minimum prestress force F1.

The deformable projection provided according to the invention need not be located at the engaging or bearing surface of the bolt or screw head but can also be disposed on the counter surface with which the screw head cooperates. As a rule, however, it will rather be unsuitable to provide such a deformable projection on a structural part to be secured by means of the screw. On the other hand, according to the invention it is possible and advantageous to provide the projection on a washer arranged between the screw head and the structural part to be secured. Such an example of embodiment is shown in FIG. 2. A washer 27 is arranged between the head 23, formed for example as hexagonal head, of a screw 21 and a structural part 25 to be secured therewith. Said washer comprises at its upper side facing the screw head 23 an annular projection 29 which bears against the planar lower side of the screw head 23 and plays the same part as the projection 11 of the screw shown in FIG. 1. The projection 29 is preferably arranged immediately adjacent the radially inner edge of the washer 27 so that after reaching a predetermined prestress force at which the projection 29 has been adequately deformed the radially further outwardly disposed region 31 of the washer 27 comes into engagement and frictional contact with the lower side of the screw head 23. The same considerations as explained with reference to FIG. 1 apply to the dimensioning of the annular projection 29.

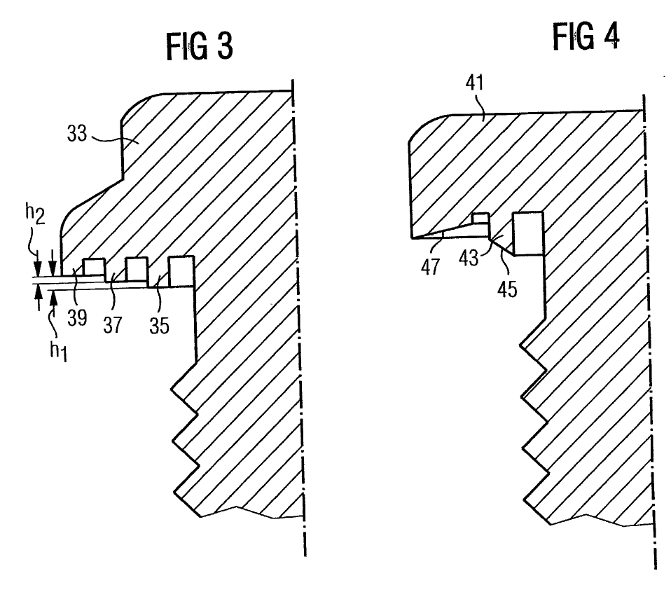

The invention is not restricted to the embodiment shown in FIGS. 1 and 2 having a single annular projection. It is possible for example to provide a plurality of annular projections with different heights decreasing radially outwardly. FIG. 3 shows a corresponding example of embodiment. The head 33 of the collar screw or bolt illustrated has at its lower side a bearing surface with an inner annular projection 35, a radially further outwardly disposed annular projection 37 and a radially outermost annular region 39 of the bearing surface, these regions being separated from each other as illustrated by annular grooves. The inner annular projection 35 has an excess height (height difference) h1 from the outer annular projection 39 which is greater, for example twice as great, as the height h2 of the centre annular projection 37. On tightening of the screw firstly the inner annular projection 35 comes to bear on the planar counter surface of the structural part or of a washer and thereafter, with increasing prestress force and deformation of the projection 35, the projection 37 comes to bear on the counter surface and with still further increasing prestress force the outer annular area 39 finally comes to bear. Consequently, the abrupt increase of the frictional resistance described above with reference to FIGS. 1 and 6 occurs twice, making it possible to achieve a still greater reduction of the tolerance range ΔF of the prestress force (FIG. 5).

The deformable projection according to the invention need not be an annular projection. It is also possible to employ projections having a non-annular base area, for example, rectangular projections or projections in the form of ring segments. In every case, it is important that the projection or the projections are arranged as far as possible in the radially inner region of the bearing surface so that after adequate deformation of the projection or projections a radially further outwardly disposed region of the bearing surface comes into engagement with the counter surface.

The profile of the projection or projections seen in axial section of the screw need not be rectangular as in the embodiments according to FIGS. 1, 2 and 3. The projection may also have a circular, triangular or trapezoidal, etc., cross-section or profile. An example of a particularly preferred profile is shown in FIG. 4. The screw head 41 of the screw illustrated in FIG. 4 has at its lower side an engaging or bearing surface having a projection 43 with an end face 45 which does not lie in a radial plane but extends inclined or conically radially outwardly. On tightening of the screw the projection 43 first comes into contact with the outer surface of the structural part at its radially inner edge region. The annular outer region 47 surrounding the projection 43 may also be bevelled, i.e. made conical, this being done radially inwardly so that its radially outer edge first comes into engagement with the counter surface. This additionally enhances the effect described above with reference to FIGS. 1 and 6.

A further preferred feature of the invention which may be employed in all the embodiments described resides in that the end face of the projection 11 and the radially further outwardly lying region 17 of the bearing surface are provided with areas of different frictional properties, in such a manner that the coefficient of friction μ of the projection 11 is substantially smaller than the coefficient of friction μ of the outer region 17 of the bearing surface. This still further greatly enhances the effect desired with the invention, i.e. the abrupt increase in the frictional resistance when on tightening of the screw connection a predetermined prestress force is reached. The different frictional properties of the end face of the projection 11 and the outer region of the bearing surface 17 may be achieved with any desired means of surface treatment familiar to the person skilled in the art. For example, the end face of the projection 11 may be polished and/or provided with a low-friction coating, and/or a lubricant may be selectively applied beneath the projection 11. Alternatively or additionally, the outer region 17 of the bearing surface may be roughened and/or provided with a friction-increasing coating.

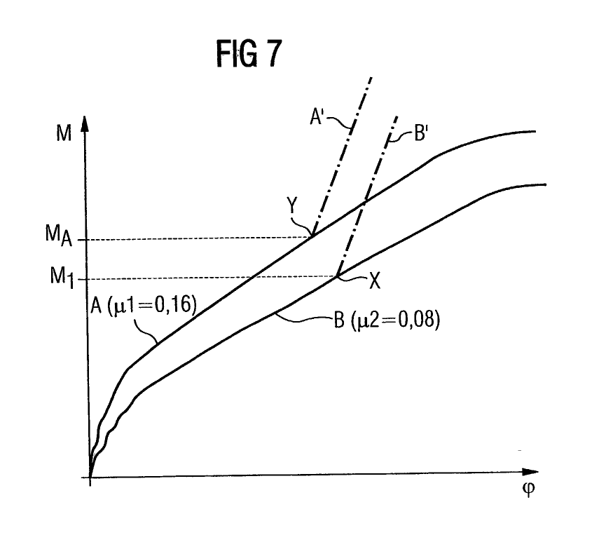

The method according to the invention for tightening a screw connection including a connecting element of the type described will be explained hereinafter with reference to FIG. 7. FIG. 7 shows the dependence of the torque M on the rotational angle Φ on tightening of a screw connection. The curve A shows the typical profile of a torque-rotational angle graph for a given coefficient of friction μ1. The curve B shows the same typical profile for a lower coefficient of friction μ2. After a steep or irregular initial portion corresponding to placing the screw head on the support surface each curve A or B has a linear increase representing the increasing elastic prestressing of the screw connection. At the end of the linear portion a flattened portion may follow which indicates a reduction of the torque increase due to plastic deformation of the screw connection. Within the linear portion of the curve A or B the slope thereof, i.e. the ratio between the torque increase and the corresponding angular increase, the so called differential quotient ΔM/ΔΦ, has a constant value. It has been known to detect the difference quotient ΔM/ΔΦ continuously during the screwing operation for example with a screw device provided with a torque sensor and angle pickup and use this to control the screwing operation (DE-OS 2751885) or to detect faulty screw connections (EP 0 587 653 B1).

As explained, on reaching a predetermined prestress force (for example point X in FIG. 6) with a screw connection according to the invention an abrupt increase occurs in the frictional resistance to the further tightening of the screw connection. As a result, the relationship between the torque and rotational angle also changes. If for example in FIG. 7 the curve B corresponds to a value μ2=0.08 and is thus comparable to the curve B′ of FIG. 6, then at the torque M1 the point X is reached at which the height difference h of the projection 11 (FIG. 1) disappears and the outer region 17 comes into frictional contact. The abrupt increase of the frictional resistance thereby occurring also leads to an abrupt change of the increase of the torque versus the angle of rotation as indicated in FIG. 7 by the dot-dash curve B40 . Correspondingly, the torque-rotational angle graph A valid for the coefficient of friction μ1=0.16 also undergoes an abrupt change in its slope on reaching the torque M_{A}, i.e. at the point Y, as indicated by the dot-dash curve A′ in FIG. 7. Thus, at the points X and Y an abrupt increase occurs in the differential quotient ΔM/ΔΦ. According to the invention, the screwing operation is controlled in such a manner that during the tightening of the screw the difference quotient ΔM/ΔΦ is continuously measured, and when a sudden increase of the differential quotient ΔM/ΔΦ occurs the tightening of the screw connection is terminated. In this manner, as apparent from FIG. 7, the tightening of the screw connection can be terminated exactly at the values of the torque M₁ or M_{A} corresponding to the minimum prestress force F1 according to FIG. 6. This leads to a defined tightening of the screw connection up to the specific minimum prestress force F1 irrespective of the prevailing particular coefficients of friction.

What is claimed:

1. Connecting element in the form of a screw, nut or washer for a screw connection, the connecting element having an annular bearing surface for bearing on a corresponding counter surface and a projection provided in said bearing surface which projection has a predetermined height difference over another area region of said bearing surface,
said projection bearing on the counter surface being adapted to be deformed and reduced in its height on tightening of the screw connection, and the height difference and area dimensions of the projection being so dimensioned that on reaching a predetermined prestress force the projection is deformed and reduced in its height to such an extent that the other area region of the bearing surface comes to bear on the counter surface, wherein the other area region of the bearing surface lies completely or mainly radially outside the projection in such a manner that as soon as the other area region of the bearing surface comes into engagement with the counter surface an increase of the mean friction diameter occurs and thus also an increase in the frictional force between the bearing surface and the counter surface.

2. Connecting element according to claim 1, wherein the projection is annular.

3. Connecting element according to claim 1, wherein the projection is defined by grooves, the depth of the grooves defining the axial height of the projection.

4. Connecting element according to claim 1, wherein a plurality of projections of different height is provided.

5. Connecting element according to claim 1, wherein the end face of the projection is inclined in such a manner that the height of said projection is greatest in the radially innermost part of said projection.

6. Connecting element according to claim 1, wherein the outer area region of the bearing surface lying radially outside the projection is inclined in such a manner that it has its greatest height at its radially outermost edge.

7. Connecting element according to claim 1, wherein the cross-sectional area of the projection, as seen in an axis-perpendicular cross-section of the connecting element is not greater than the cross-sectional area of the shank of the screw or bolt of the screw connection.

8. Connecting element according to claim 1, wherein the end face of said projection and the area region of the bearing surface lying radially outside the projection have different frictional properties in such a manner that the friction at the counter surface beneath the projection is considerably less than that beneath the radially outwardly disposed area region.

9. Connecting element according to claim 1, wherein the connecting element is a screw and the projection is arranged on the lower side of the screw head.

10. Connecting element according to claim 1, wherein the connecting element is a washer and the projection is arranged on the side of the washer which faces the screw head on assembly of the screw connection.

11. Method for tightening a screw connection as claimed in claim 1 comprising;
tightening of the screw connection, measuring continuously the torque and the rotational angle while tightening, and calulating the differential quotient of the torque and rotational angle; and
terminating the tightening of the screw connection when an abrupt increase in the differential quotient is detected during the tightening.

12. Connecting element according to claim 2, wherein the projection is defined by grooves, the depth of the grooves defining the axial height of the projection.

13. Connecting element according to claim 2, wherein a plurality of projections of different height is provided.

14. Connecting element according to claim 2, wherein the end face of the projection is inclined in such a manner that the height of said projection is greatest in the radially innermost part of said projection.

15. Connecting element according to claim 4, wherein the outer area region of the bearing surface lying radially outside the projection is inclined in such a manner that it has its greatest height at its radially outermost edge.

16. Connecting element according to claim 4, wherein the cross-sectional area of all the projections, as seen in an axis-perpendicular cross-section of the connecting element is not greater than the cross-sectional area of the shank of the screw or bolt of the screw connection.

17. Connecting element according to claim 2, wherein the end face of said projection and the area region of the bearing surface lying radially outside the projection have different frictional properties in such a manner that the friction at the counter surface beneath the projection is considerably less than that beneath the radially outwardly disposed area region.

18. Connecting element according to claim 4, wherein the connecting element is a screw and the projections are arranged on the loweer side of the screw head.

19. Connecting element according to claim 2, wherein the connecting element is a washer and the projection is arranged on the side of the washer which faces the screw head on assembly of the screw connection.

20. Connecting element in the form of a screw, nut or washer for a screw connection, the connecting element having an annular bearing surface for bearing on a corresponding counter surface and at least one projection provided in said bearing surface which projection has a predetermined height difference over another area region of said bearing surface,
each said projection bearing on the counter surface being adapted to be deformed and reduced in its height on tightening of the screw connection, and the height difference and area dimensions of each projection being so dimensioned that on reaching a predetermined prestress force the projection is deformed and reduced in its height to such an extent that the other area region of the bearing surface comes to bear on the counter surface, wherein the other area region of the bearing surface lies completely or mainly radially outside each said projection in such a manner that as soon as the other area region of the bearing surface comes into engagement with the counter surface an increase of the mean friction diameter occurs and thus also an increase in the frictional force between the bearing surface and the counter surface.
